(19) United States
(12) Patent Application Publication
(10) Pub. No.: US 2019/0375023 A1
(43) Pub. Date: Dec. 12, 2019

(54) TURNING DEVICE FOR STATIC BAR

(71) Applicant: BUCCI AUTOMATIONS S.P.A., Faenza (IT)

(72) Inventors: Dario CUSUMANO, Faenza (IT); Nicolo' VINCENZI, Faenza (IT)

(21) Appl. No.: 16/438,547

(22) Filed: Jun. 12, 2019

(30) Foreign Application Priority Data
Jun. 12, 2018 (IT) 102018000006221

(51) Int. Cl. B23B 3/26

(52) U.S. Cl. CPC B23B 3/26; B23B 2250/16; B23B 2250/04; B23B 2260/062

(57) ABSTRACT

A turning device with static bar includes a motor, a driving shaft and a sleeve, which defines a seat for temporarily accommodating at least one portion of the bar being machined. A machining tool is coupled directly or indirectly on the sleeve. A secondary shaft is interposed between the driving shaft and the sleeve and is coupled to the screw of a first assembly constituted by a first recirculating-ball screw and a respective first lead screw integral with the sleeve. The sleeve and first assembly are coaxial and the driving shaft axis is parallel to and separate from the common axis of the sleeve and first assembly.

The device includes an adjustment element coupled to a pusher shaft, which through the secondary shaft.

makes the screw translate and the assembly lead screw rotate, with consequent rotation of the sleeve and a movement in a radial direction of the tool.

### CROSS REFERENCE TO RELATED APPLICATIONS

This application claims priority to Italian Patent Application No. 102018000006221, filed on Jun. 12, 2018, the contents of which are hereby incorporated by reference in their entirety.

### TECHNICAL FIELD

The present disclosure relates to a turning device with static bar.

### BACKGROUND

The operation of lathes generally involves clamping the bar to be machined in a spindle, which then rotates it. The tool that is used to remove material from the bar can be moved (hewing the surface of the bar) in a radial and/or longitudinal direction.

For fixed-bar lathes, on the other hand, the bar is rigidly coupled to the fixed frame, in a cantilevered arrangement, while the tool is arranged on a rotating assembly that can be moved around the bar while executing the desired machining.

This second type of lathe is particularly efficient for some specific kinds of machining and therefore it is quite widespread.

The particular architecture of such lathes determines some problems.

First of all it is necessary to make the tools machine in a cantilevered arrangement and this implies a number of competing possible problems.

If the supporting arms of the tools are generously dimensioned they can provide a good overall rigidity and, therefore, a high precision of the machining, but, against this, it will also determine a considerable increase of the rotating masses, with consequent problems of dimensioning and balancing.

More slender supporting arms are less subject to phenomena of inertia and any vibrations can be reduced (eliminated) through easy balancing operations, but, by contrast, they can undergo slight deformations during the turning operations, which reduce their precision.

Furthermore the movement of the tool is generally very complicated, in that it is necessary to be able to execute it during rotation of the entire assembly that supports it. Often, executing continuous changes of position of the tool during machining is extremely complicated and does not ensure the necessary precision.

Finally, it must be remembered that this type of machine tool requires continual and frequent maintenance (in particular with regard to the need for lubrication) which entails machine stops and significant costs.

### SUMMARY

The aim of the present disclosure is to solve the above mentioned drawbacks, by providing a turning device with static bar that ensures a high level of precision.

Within this aim, the disclosure provides a turning device with static bar of low mass.

The disclosure also provides a turning device with static bar that is easily balanced.

The disclosure further provides a turning device with static bar in which the movement of the tool is precise and efficient and can be executed even during the turning operations.

The disclosure also provides a turning device with static bar that requires minimal maintenance.

The disclosure further provides a turning device with static bar that does not require lubrication of the moving parts.

The present disclosure provides as turning device with static bar which is of low cost, easily and practically implemented, and safe in use.

This aim and these and other advantages that will become better apparent hereinafter are achieved by providing a turning device with static bar of the type comprising a motor, a driving shaft and a sleeve, which defines a seat for temporarily accommodating at least one portion of the bar being machined, a machining tool being coupled directly or indirectly on said sleeve, wherein:

a secondary shaft is interposed between said driving shaft of said motor and said sleeve and is coupled to the screw of a first assembly which is constituted by a first recirculating-ball screw and a respective first lead screw, said lead screw being integral with said sleeve,

said sleeve and said first assembly being coaxial and the axis of the driving shaft being parallel to and separate from the common axis of the sleeve and of the first assembly;

the device comprises an adjustment element which is coupled to a pusher shaft which is associated with said secondary shaft.

### BRIEF DESCRIPTION OF THE DRAWINGS

Further characteristics and advantages of the disclosure will become better apparent from the detailed description that follows of a preferred, but not exclusive, embodiment of the turning device with static bar according to the disclosure, which is illustrated by way of non-limiting example in the accompanying drawings, wherein:

FIG. 1 is a cross-sectional side view, taken along a longitudinal plane, of a device according to the disclosure in a first operating configuration, which is driven by a motor/pulley assembly;

FIG. 2 is a cross-sectional side view, taken along a longitudinal plane, of the device in FIG. 1 in a second operating configuration;

FIG. 3 is a front elevation view of the device in FIG. 1;

FIG. 4 is a schematic front elevation view of a first arrangement of the tool with respect to the bar in the device in FIG. 1;

FIG. 5 is a schematic front elevation view of a second arrangement of the tool with respect to the bar in the device in FIG. 1;

FIG. 6 is a schematic front elevation view of a third arrangement of the tool with respect to the bar in the device in FIG. 1; and

FIG. 7 is a cross-sectional side view, taken along a longitudinal plane, of a device according to the disclosure in a first operating configuration, which is driven by a linear actuator.

### DETAILED DESCRIPTION OF THE DRAWINGS

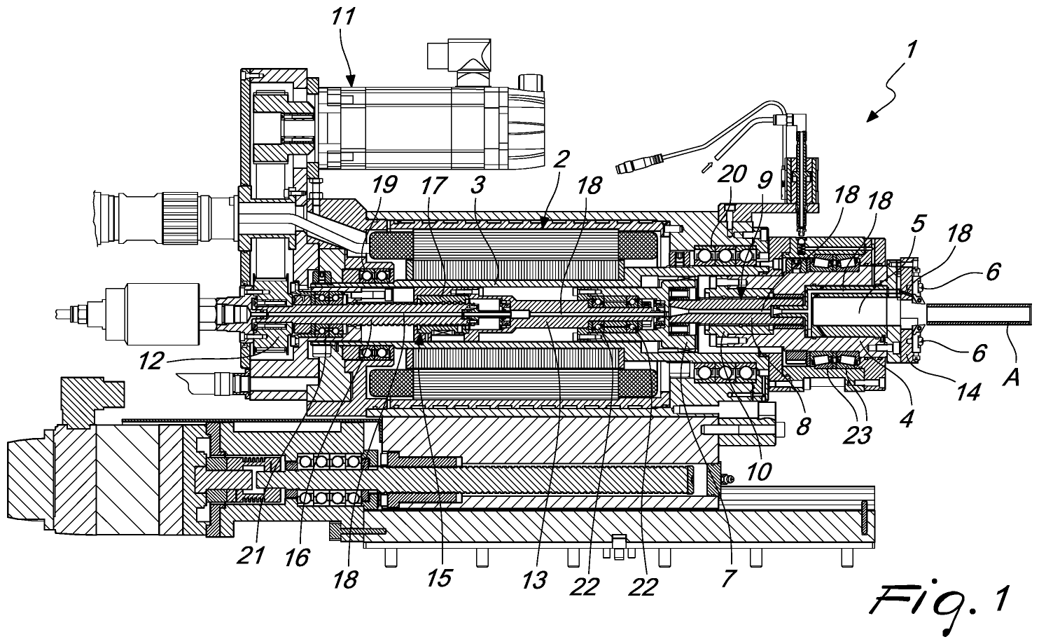

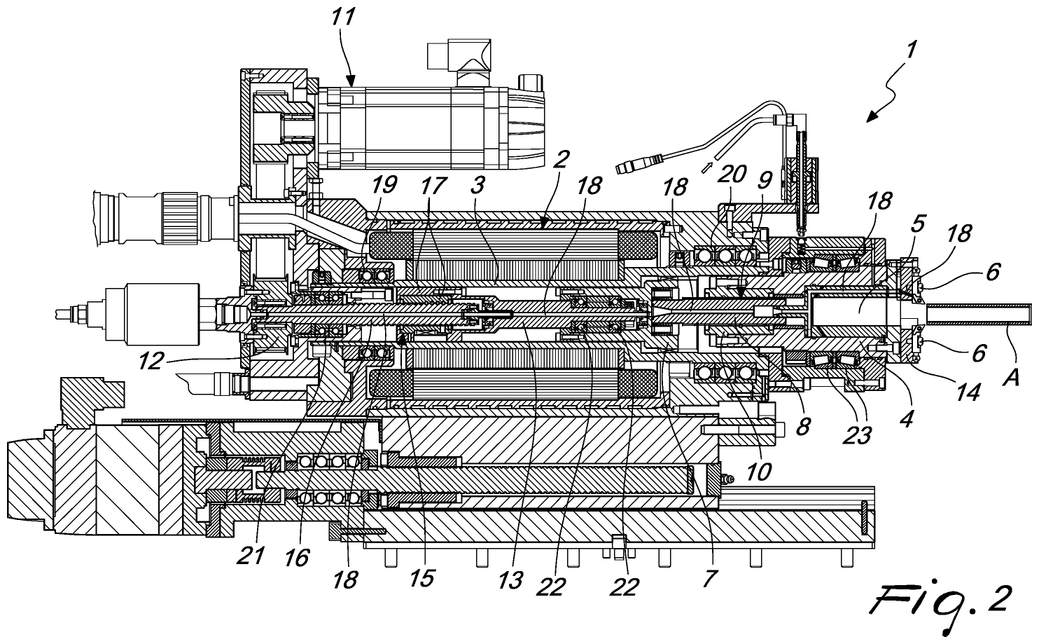

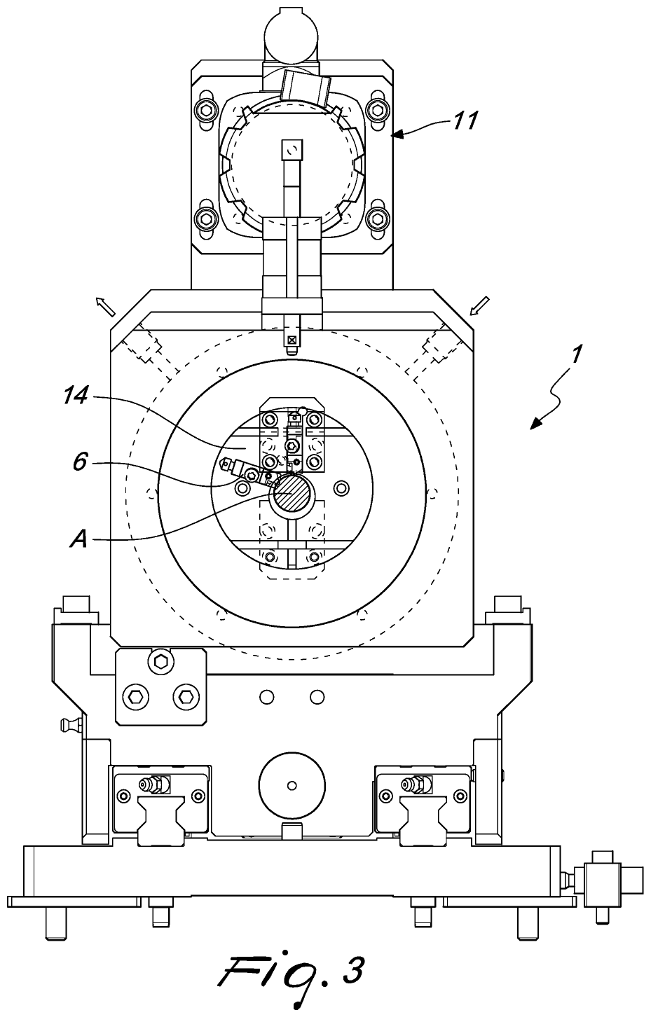

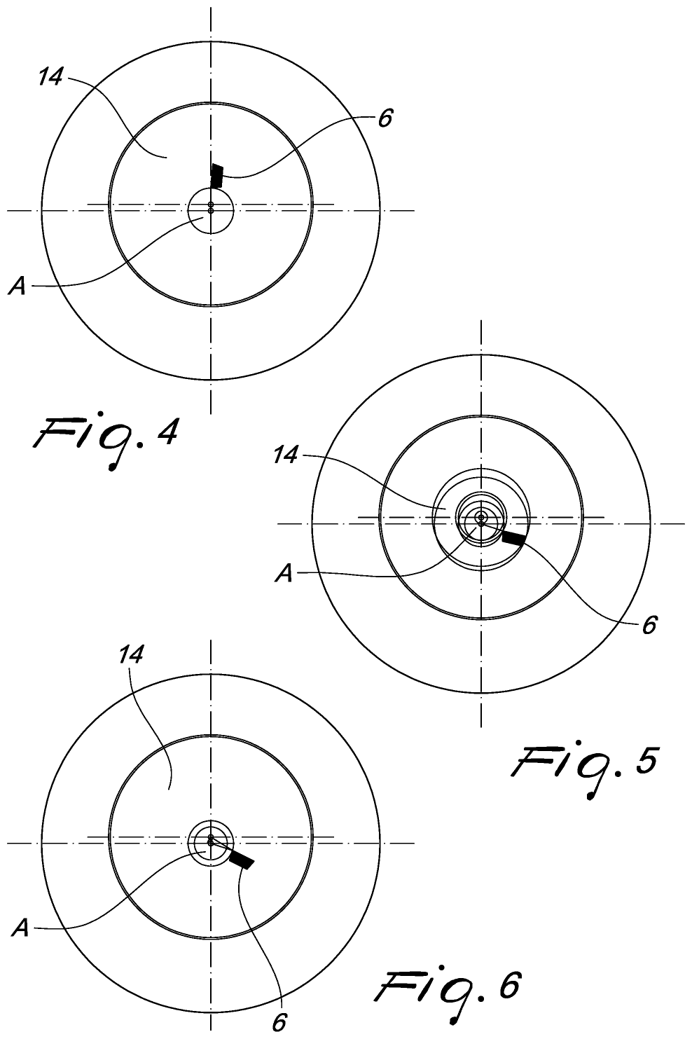

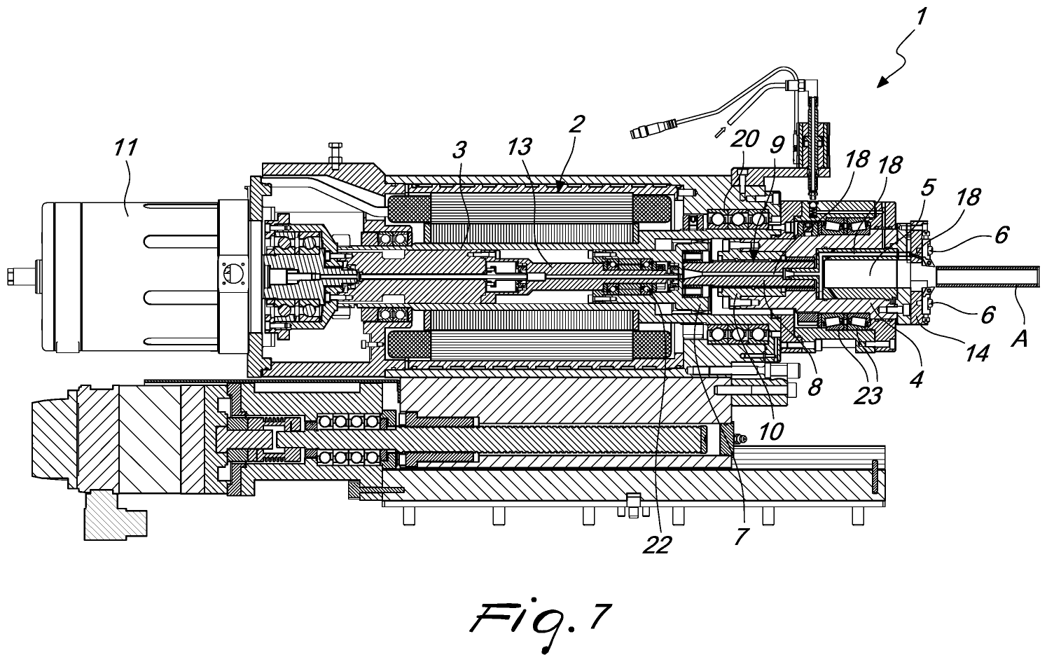

With particular reference to FIGS. 1-7, the reference numeral 1 generally designates a turning device with static bar A.

The device 1 comprises a motor 2 of which the driving shaft 3 supports a sleeve 4, which defines a seat 5 for temporarily accommodating at least one portion of the bar A being machined.

A machining tool 6 is coupled on the sleeve 4 (directly or indirectly, i.e. with the interposition of other components).

A secondary shaft 7 is interposed between the driving shaft 3 of the motor 2 and the sleeve 4 and is coupled to the screw 8 of a first assembly 9 which is constituted by a first recirculating-ball screw 8 and a respective first lead screw 10.

The lead screw 10 is integral with the sleeve 4.

It should be noted that the motor 2, the driving shaft 3, the secondary shaft 7, the first screw/lead screw assembly 9 and the sleeve 4 are hollow in the device 1 according to the disclosure; as will be seen below, this particular shape structure brings undoubted advantages in terms of cooling and lubrication (by allowing the passage of specific fluids).

Since these are axially-symmetrical components, it should be noted that they will have a substantially tubular shape structure; since all the cited components are mutually coaxial, the respective internal cavities will also be mutually coaxial.

The sleeve 4 and the first assembly 9 are conveniently coaxial.

The axis of the driving shaft 3 on the other hand is parallel to and separate from the common axle of the sleeve 4 and of the first group 9, thus defining an eccentricity thereof with respect to such components.

It should furthermore be noted that the device 1 according to the disclosure comprises an adjustment element 11, which is coupled to an adjustment shaft 12 which can be situated, in a specific application described by way of non-limiting example, in a position arranged opposite from the sleeve 4.

The adjustment shaft 12 is in turn coupled (directly or indirectly, i.e. with the interposition of further components) to a pusher shaft 13.

The pusher shaft 13, through the secondary shaft 7, can generate the translation of the screw 8 and the rotation of the lead screw 10 (as a direct consequence) of the assembly 9.

Such rotation of the lead screw 10 implies a corresponding rotation of the sleeve 4 (which is integral with it) and a movement in a radial direction of the tool 6, i.e. in approach to/distancing from the axis of the motor 2.

In a specific embodiment which is described by way of non-limiting example, the terminal end of the pusher shaft 13 is in turn coupled (in this case too it will generally be an indirect coupling, i.e. with the interposition of other components) to an end flange 14 that can rotate eccentrically on the sleeve 4.

The tool 6, in this case, will be integral with such flange 14.

Again with reference to the embodiment cited by way of non-limiting example above, it should be noted that the rotations of the flange 14 (which as a result of the eccentricity will cause movements in a radial direction of the tool 6, with consequent variation of the depth of the incision made by it on the bar A to be machined) will occur by virtue of the action of the pusher shaft 13, which by pushing on the first recirculating-ball screw 8 of the first screw/lead screw assembly 9 will determine a translation of the screw 8, with consequent rotation of the lead screw 10 (which is integral with the flange 14, which will rotate eccentrically with respect to the sleeve 4).

According to a particular embodiment of undoubted practical and applicative interest, a second assembly 15 can be interposed between the adjustment shaft 12 and the pusher shaft 13 and comprises a second recirculating-ball screw 16 with a corresponding second lead screw 17.

The second screw 16 and the second lead screw 17 are, in such case, accommodated at least partially in the inner cavity of the driving shaft 3 and the second lead screw 17 will be integral with the pusher shaft 13 which translates inside the driving shaft 3.

The terminal end of the pusher shaft 13, coupled to the first recirculating-ball screw 8, will ensure the corresponding translation, with consequent rotation of the flange 14 and displacement of the tool 6 toward or away from the common axle of the sleeve 4 and of the bar A to be machined.

With particular reference to an alternative embodiment to the one described previously, which is also extremely advantageous from an applicative point of view, the adjustment element 11 can conveniently be a numerically-controlled linear actuator (of the type of a numerically-controlled electric cylinder, although the possibility of using different actuators powered by electricity, pneumatics, hydraulics and the like, is not excluded) which is provided with an adjustment shaft 12 which is coaxial to and integral with the pusher shaft 13.

It should be noted that in the device 1 according to the disclosure the tool 6 is arranged radially with respect to the central hole of the flange 14, with the cutting edge protruding from the inner edge of such hole.

An eccentric rotation of the flange 14, by virtue of the action of the adjustment element 11, generates a translation of the cutting edge in a direction which is radial with respect to the axis of the bar A to be machined and which coincides with the axis of the sleeve 4.

In order to permit a correct cooling and lubrication of the cutting edge of the tool 6, as well as of the bar A that is subjected to turning, it should be noted that the adjustment shaft 12, the second assembly 15 (which comprises the second screw 16 and the second lead screw 17) and the pusher shaft 13 are axially hollow: thanks to the presence of such cavities (and of the axial cavities that are present in the first assembly 9, and the presence of a channel inside the flange 14) a continuous duct 18 is therefore defined which leads to a dispensing nozzle which faces and is proximate to the cutting edge of the tool 6.

Such passage 18 will be connected, upstream, to an apparatus for supplying refrigerant fluid (for example a pump that can ensure the necessary pressure is applied to the fluid conveyed in the passage 18), for the corresponding flow through the passage 18 and the distribution onto the cutting edge of the tool 6 and onto the bar A during turning.

It should be noted that the dispensing nozzle can positively be of the type of an atomizer, a sprayer and the like; the possibility is not ruled out however of adopting a continuous flow of refrigeration and/or lubrication fluid dispensed by way of one or more nozzles or other dispensing devices.

According to a particular embodiment of undoubted practical and applicative interest, the adjustment element 11 comprises a servomotor which is coupled rigidly to the adjustment shaft 12.

The servomotor in such case can advantageously be arranged preferably in a configuration selected from coaxial with the adjustment shaft 12, with direct coupling of the shaft of the servomotor to the adjustment shaft, and offset with respect to the adjustment shaft 12, with the interposition of transmission means preferably of the toothed type (for example the coupling can be implemented using gearwheels or by way of a toothed belt or a chain). In a preferred embodiment, the axis of the servomotor is parallel to the axis of the adjustment shaft 12 (embodiment shown by way of example in the accompanying figures).

It further needs to be specified that the motor 2 is, preferably, an electrospindle with a hollow rotor. Hollow rotor electric motors used as electric spindles are traditional electric motors in which the rotor has an axial cavity inside which other components can be inserted (arranged), either integral with the rotor, such as the driving shaft 3, or separate from it, such as the pusher shaft 13.

The driving shaft 3 is supported by bearings 19, 20 with radial action which are coupled upstream (the bearings 19) and downstream (the bearings 20) to the fixed frame of the motor 2.

Radial-action bearings 21 are interposed between the driving shaft 3 and the second recirculating-ball screw 16, accommodated at least partially inside the driving shaft 3.

It should furthermore be noted that respective radial-action bearings 22 are interposed between the secondary shaft 7 and the pusher shaft 13, arranged inside it, for supporting the pusher shaft 13 and its free axial translational movement according to a preset stroke (in order to allow the necessary thrust to be exerted on the first screw/lead screw assembly 9 intended to adjust the angular position of the flange 14 and therefore the interference of the tool 6 (more precisely of its cutting edge) with the bar to be machined A.

It should be noted on the other hand that the sleeve 4 is supported by bearings 23 for radial and axial support, preferably of a type selected from conical roller bearings, inclined ball bearings and the like.

In practice the device 1 according to the disclosure, during execution of the turning of a bar A, allows an adjustment of the interference of the cutting edge of the tool 6, which is carried out by way of the thrust exerted by the pusher shaft 13 on the first screw/lead screw assembly 9, which converts the translation imposed by the pusher shaft 13 on the first recirculating-ball screw 8 to a rotation of the lead screw 10, which is integral with the bracket 14 to which the tool 6 is coupled. Since the bracket 14 can rotate eccentrically with respect to the axis of the bar A, a rotation of it implies an approach (or distancing) of the cutting edge of the tool 6 toward (or away from) the axis of the bar A (displacement in a radial direction of the tool 6) and therefore a variation of the depth of incision of the cutting edge on the bar A.

Advantageously the present disclosure solves the above mentioned problems, by providing a turning device 1 with static bar A that ensures a high level of precision: in fact the tool 6 is rigidly coupled to the bracket 14 and is not in a cantilevered arrangement, thus minimizing the risk of inaccuracies owing to play or bending.

Conveniently the device 1 according to the disclosure has a substantially low mass, which in any case does not exceed that of conventional devices.

Conveniently the device 1 according to the disclosure is easily balanced, since most of the components are axially symmetrical and therefore, when rotated, do not cause vibrations owing to the presence of masses that are eccentric to that rotation.

Conveniently the device 1 according to the disclosure is substantially free from play in particular, thanks to the presence of preloaded components, and is free from play at points of reversal of motion.

Advantageously in the device 1 according to the disclosure the movement of the tool 6 is precise and efficient and can be executed even during the turning operations.

Profitably the device 1 according to the disclosure requires minimal maintenance: in fact the bearings 19, 20, 21, 22, 23 do not require periodic lubrication but need only be covered with the right amount of grease in the assembly step only. It has been found therefore that the entire device 1 does not require frequent and periodic maintenance interventions, with considerable advantages in terms of cost and productivity with respect to conventional devices.

Effectively the device 1 according to the disclosure does not require lubrication of the moving parts.

Positively the present disclosure makes it possible to provide a turning device 1 with static bar A that is easily and practically implemented and substantially of low cost: such characteristics make the device 1 according to the disclosure an innovation that is safe in use.

The disclosure, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

1. A turning device with static bar comprising a motor, a driving shaft and a sleeve, which defines a seat for temporarily accommodating at least one portion of the bar being machined, a machining tool being coupled directly or indirectly on said sleeve, wherein:
a secondary shaft is interposed between said driving shaft of said motor and said sleeve and is coupled to a screw of a first assembly constituted by a first recirculating-ball screw and a respective first lead screw, said lead screw being integral with said sleeve,
said sleeve and said first assembly being coaxial and the axis of the driving shaft being parallel to and separate from a common axis of the sleeve and of the first assembly;
the device further comprises an adjustment element coupled to a pusher shaft associated with said secondary shaft,
said pusher shaft, through said secondary shaft, causing a translation of a screw and a rotation of said lead screw of the assembly, with consequent rotation of said sleeve and a movement in a radial direction of said tool.

2. The device according to claim 1, wherein a second assembly is interposed between an adjustment shaft and said pusher shaft of said adjustment element and comprises a second recirculating-ball screw with a corresponding second lead screw, said second screw and said second lead screw being accommodated at least partially in the inner cavity of said driving shaft and said second lead screw being integral with said pusher shaft which translates inside said driving shaft, the terminal end of said pusher shaft being coupled to said first recirculating-ball screw for the corresponding translation, said tool being integral with a flange which can rotate eccentrically with respect to the terminal edge of said sleeve by virtue of the action of said first lead screw.

3. The device according to claim 1, wherein said adjustment element is a numerically-controlled linear actuator provided with an adjustment shaft, said adjustment shaft being coaxial and integral with said pusher shaft.

4. The device according to claim 1, wherein said motor, said driving shaft, said secondary shaft, said first screw/lead screw assembly and said sleeve are hollow, said cavity being adapted for the conveyance of a flow of fluid.

5. The device according to claim 2, wherein said adjustment shaft, said second assembly which comprises said second screw and said second lead screw, and said pusher shaft are axially hollow, a continuous duct being defined in the cavity of said adjustment shaft, said second screw/lead screw assembly, said pusher shaft, said first screw/lead screw assembly and a channel inside said flange, said duct leading to a dispensing nozzle which faces and is proximate to the cutting edge of said tool, said duct being connected upstream to an apparatus for supplying refrigerant fluid, for the flow thereof through the duct and distribution onto the cutting edge of the tool and onto the bar during turning.

6. The device according to claim 2, wherein said adjustment element comprises a servomotor coupled rigidly to said adjustment shaft, said servomotor being arranged in a configuration selected from coaxial to said adjustment shaft, with direct coupling of the shaft of the servomotor to the adjustment shaft, and offset with respect to said adjustment shaft, with the interposition of transmission means preferably of the toothed type.

7. The device according to claim 1, wherein said motor is an electrospindle with a hollow rotor.

8. The device according to claim 2, wherein said machining tool is arranged radially with respect to the central hole of said flange, with the cutting edge protruding with respect to the inner edge of said hole, an eccentric rotation of said flange, by virtue of the action of said adjustment element, generating a translation of said cutting edge in a direction which is radial with respect to the axis of the bar to be machined and which coincides with the axis of said sleeve.
